(19) United States
(12) Patent Application Publication
(10) Pub. No.: US 2020/0245440 A1
(43) Pub. Date: Jul. 30, 2020

(54) METHODS AND DEVICES FOR HARVESTING IONIC ENERGY TO PRODUCE ELECTRICITY

(71) Applicants: Maxwell Loughan, Incline Village, NV (US); David Shoup, Huntington Beach, CA (US); Matthew Heisie, Woodland Hills, CA (US)

(72) Inventors: Maxwell Loughan, Incline Village, NV (US); David Shoup, Huntington Beach, CA (US); Matthew Heisie, Woodland Hills, CA (US)

(21) Appl. No.: 16/259,265

(22) Filed: Jan. 28, 2019

(51) Int. Cl. H05F 7/00; H02N 1/00; H02J 50/00; H05F 3/04

(52) U.S. Cl. CPC H05F 7/00; H05F 3/04; H02J 50/00; H02N 1/002

(57) ABSTRACT

A system for harvesting atmospheric ionic energy to generate electricity is provided. The present invention embodies the utilization of the electric equipotential differences in the earth's electrostatic field through providing a generator device extending vertically into the atmosphere perpendicular to ground. The generator device includes electrical collectors adapted to conduct surface charge. A ground circuit coupled to the generator device is adapted to distribute the surface charge to attract oppositely charged atmospheric ions so that the electrostatic energy is converted to a low amperage, high voltage transaction of moving electrons up though the apparatus, reciprocal in direction to the electrostatic field previously mentioned so as to be useable for conventional electrical systems.

### BACKGROUND OF THE INVENTION

The present invention relates to electrical generators and, more particularly, to a system for harvesting atmospheric ionic energy to generate electricity.

The ‘duck curve’ is a problem that has haunted green energy advocates for decades. Power demand peaks in the morning and the evening, but energy production from solar peaks during the middle of the afternoon. Power storage from the solar panels is costly and wasteful. Besides photons of light that are harnessed by solar panels to create electricity, other subatomic particles exist in the atmosphere that carry the energy to create an electron flow.

Electrically charged ions are present in the Earth's atmosphere day and night all around the world. They are present due to the cosmic energy that positively charges the Earth's ionosphere and flow to the Earth due to its high ground potential. This is sometimes referred to as “Atmospheric Electricity.” Effectively, the relationship between the ionosphere and the surface of the Earth emulates a giant capacitor. Evidence of the presence of this energy is found in the increased conductivity and radioactivity in the upper layers of the atmosphere and while another is the Aurora Borealis. In both these cases, atmospheric conditions take on a form that results in the conversion of these charged particles. In the absence of these conditions it is still possible to harvest this energy and convert this energy into more a more useful and usable form, electricity.

But, no technology exists to harness that potential energy in a useful fashion. Since Nikola Tesla first patented his Apparatus for the Utilization of Radiant Energy (U.S. Pat. No. 685,957) in 1901, people have been searching for an effective and efficient way to tap into this endless supply of ionic energy and turn it into something useful. One patent provides for the extraction of low frequency energy below the surface of the Earth (U.S. Pat. No. 9,564,268), which has not been shown capable of producing higher voltage power. Another patent provides a method to gather electromagnetic interference (EMI) (U.S. Pat. No. 7,173,343) generated by power lines and electrical devices. However, this requires a source of existing power transmission to function, and only a tiny fraction of the transmitted power is captured.

As can be seen, there is a need for a system for harvesting atmospheric ionic energy to generate electricity. The present invention embodies the utilization of the electric equipotential differences in the earth's electrostatic field, maintained by the ionosphere and generated primarily through various methods including but not limited to, cosmic cascade ion formation, solar radiation, and other upper atmospheric phenomena. The apparatus is presented by grounding a wire extending vertically into the atmosphere perpendicular to ground. At the end of the apparatus, there are one or more collectors, tasked with using physical shape and atomic form to manipulate the conducted surface charge (−) and distribute the surface charge (from the apparatus summiting the conductor) to positively charged cations. Electrons are conducted through the apparatus, and use the opposite attracting charge to attract and neutralize both big and small ions (generated by the cosmic cascade process) by distributing electrons. This process results in the low amperage, high voltage transaction of moving electrons up though the apparatus, reciprocal in direction to the electrostatic field previously mentioned. Distributed via ground circuitry, the electrostatic charge manifested by the apparatus is applied by utilising (but not limited to), spark gap, electrostatic motors, and more. Then it is converted into a useable wattage by manipulating the interchangeability of voltage, resistance and amperage,

The present invention for harnessing power is the only technology shown to reliably create a net positive stream of electrons from the ionosphere in a form that could be usable for electrical applications.

### SUMMARY OF THE INVENTION

In one aspect of the present invention, a system for harvesting atmospheric ionic energy to generate useable electricity includes one or more collectors positioned in a preselected portion of the earth's electrostatic field, the one or more collectors adapted to conduct a surface charge; and a ground circuit electrically coupled to the one or more collectors, the ground circuit configured to distribute the surface charge so as to provide a potential difference between the one or more collectors and said preselected portion.

In yet another aspect of the present invention, the system for harvesting atmospheric ionic energy to generate useable electricity includes one or more collectors positioned in a preselected portion of the earth's electrostatic field, the one or more collectors provide a conducting surface configured to conduct a surface charge; a ground circuit electrically coupled to the one or more collectors; the ground circuit comprises an electrolytic circuit and a unidirectional circuit configured to distribute the surface charge so as to provide a potential difference between the one or more collectors and said preselected portion, wherein the conducting surfaces are connected to a single point of high ground potential for instilling the potential difference; and an electrostatic conversion apparatus coupled to the ground circuit for converting the surface charge to an electrical charge.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention, shown in use;

FIG. 2 is a schematic view of an exemplary embodiment of the present invention;

FIG. 3 is a circuit diagram of an exemplary embodiment of the present invention;

FIG. 4 is a circuit diagram of an exemplary embodiment of the present invention;

FIG. 5 is a circuit diagram of an exemplary embodiment of the present invention;

FIG. 6 is a schematic view of an exemplary embodiment of the present invention; and

FIG. 7 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

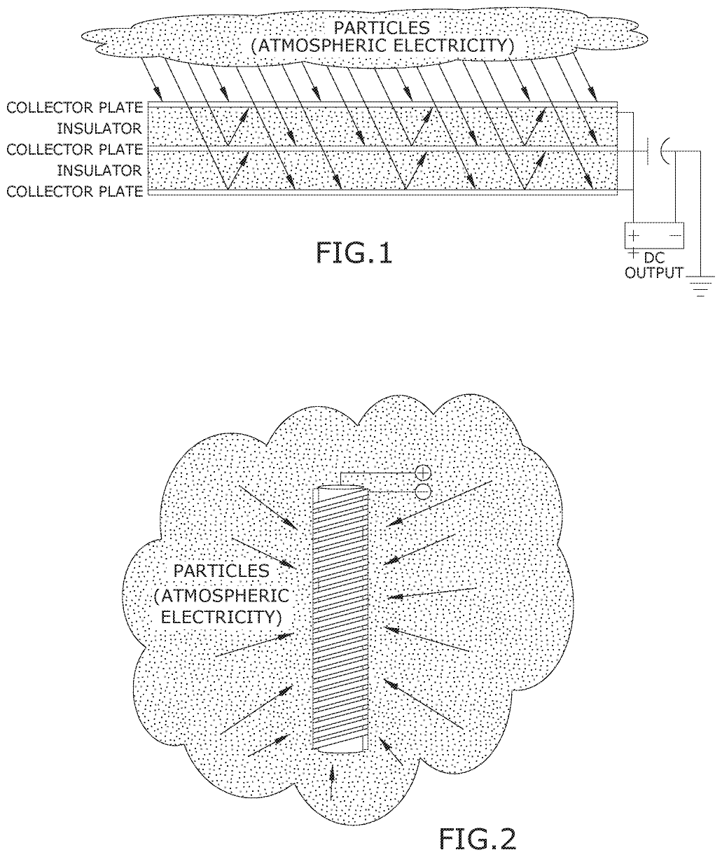

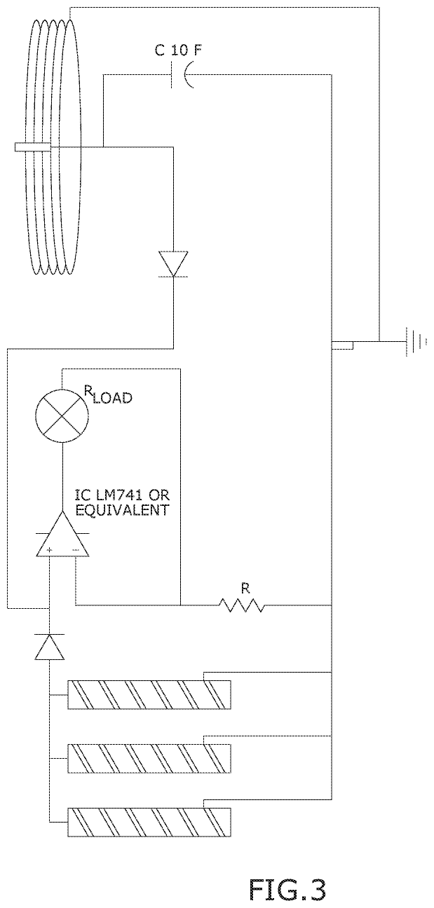

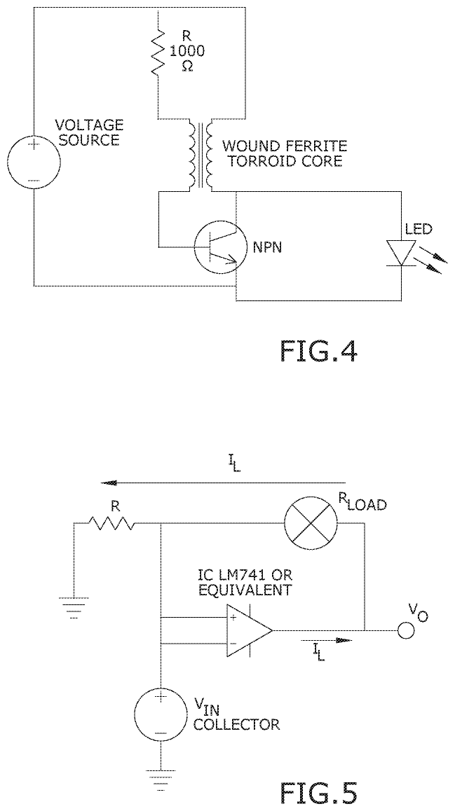

Referring to FIGS. 1 through 7, the present invention may include a system for harvesting atmospheric Ionic energy to generate electricity. The atmospheric Ionic energy results from cosmic radiation in space colliding with gases in the terrestrial atmosphere, wherein a global charge differential is created between the charged ionosphere and ground. The system present invention embodies one or more conductive surfaces or collectors 20 coupled to a generator device 10 positioned or arranged to optimize the collision and/or attraction of naturally occurring ions at a subatomic level.

The collectors 20 on the generator device 10 are connected by conducting material at a single point which is connected to a high ground potential to provide a potential difference between it and the surrounding atmosphere. The generator device 10 is electrically connected to a ground circuit 50 adapted to direct the charge through electrical systems that detect and transfer the charge into useable electricity. The ground circuit 50 is adapted distribute the electrostatic charge manifested by the generator device 10 and converted to electrical charge by a spark gap, electrostatic motors, or others electro.

The ground circuit 50 includes, at minimum, an electrolytic circuit and a circuit that allows only a single direction of electron flow to or from the powerful ground potential. Although the ground circuit 50 may vary depending on the application, it usually involves a furthering of the charge at the top of the generating device 10 (however high it may be elevated), via an electrical connection into electrostatic motors, spark gaps, transformation processes such as the blocking oscillators, and boost converters, other electrical systems, and/or power storage devices, connected directly to a DC device for consumption, and/or immediately fed into a grid for consumption.

In summary, the generator device 10 embodies a utilization of the electric equipotential differences in the earth's electrostatic field, maintained by the ionosphere and generated primarily through various methods including but not limited to, cosmic cascade ion formation, solar radiation, and other upper atmospheric phenomena. The generator device 10 is presented by grounding a wire extending vertically into the atmosphere perpendicular to ground. At the end of the generator device 10, there are one or more collectors 20, tasked with using physical shape and atomic form to manipulate the conducted surface charge (−) and distribute the surface charge (from the generator device 10) to positively charged cations. Electrons are conducted through the generator device 10. The system may be adapted to use the opposite attracting charge to attract and neutralize both big and small ions (generated by the cosmic cascade process) by distributing electrons. This process results in the low amperage, high voltage transaction of moving electrons up though the apparatus, reciprocal in direction to the electrostatic field previously mentioned.

The sequence of the systems may always lead with the conductors—the collectors 20—followed by electrostatic conversion apparatuses (such as the ones listed above). The generator device 10 has the leniency to undergo many forms, dependent on the area, desired output, and environmental discretion. Although there is variation, the primary concept is to provide conductive materials, either metals such as aluminum and/or copper, and/or other conductors (such as graphite or graphene) in the form of collectors 20. Next, they must be fashioned into a conductive surface, taking the forms of either plates, spheres, points, or a lattice structure of intersections. Many of the potential ground circuit 50 additions beyond the electrolytic and diode component serve merely to amplify or boost the effect of the collectors 20.

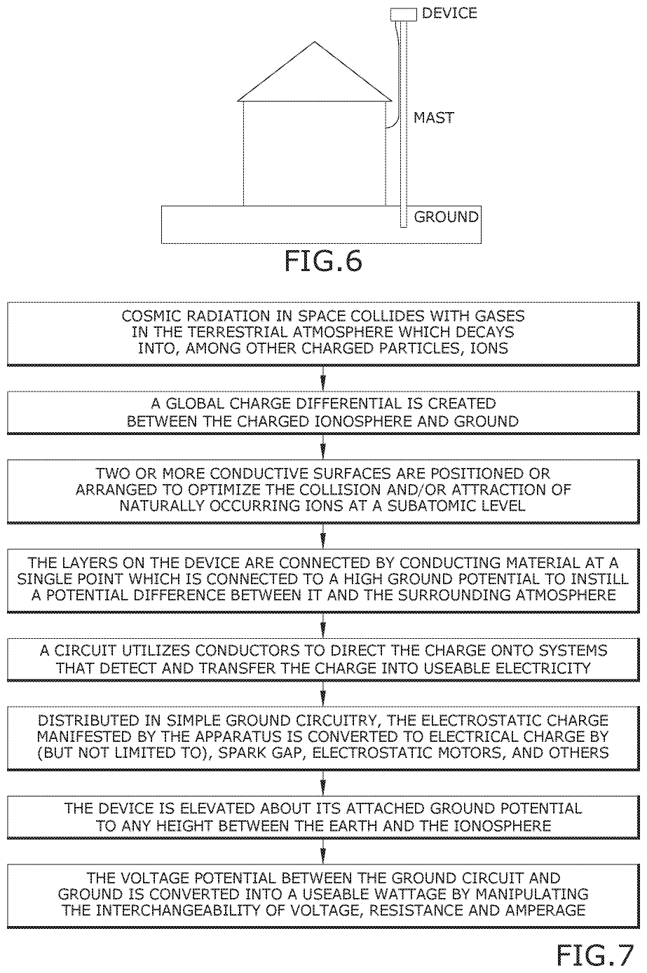

A method of using the present invention may include the following. The system disclosed above may be provided. A user may elevate the generator device 10 above its attached ground potential to any height between the earth and the ionosphere. In certain embodiments, the user is attempting to maximize the generator device's 10 distance from ground. For instance, a user may start by driving a ground rod into the ground of the location desired for application, as illustrated in FIG. 6. After the ground has been installed, one must construct or install the ground circuit 50. A pole to elevate the device is not strictly necessary. It can be elevated in other ways, such as being hooked to a balloon, or any other method of elevation capable of achieving distance from ground.

A conductive wire may be placed on the bottom of the generator device 10 above and lead down to the ground where it is connected to the ground and accompanying ground circuit 50. The voltage potential between the ground circuit 50 and ground is converted into a useable wattage by manipulating the interchangeability of voltage, resistance and amperage.

Designed as an alternative for small scale solar, or an addition to a solar panel to provide 24-hour production, the present invention alleviates or reduced the need for batteries because the device produces electricity all hours of the day and night. Instead, so-called capacitor storage systems can be used which have a useful lifespan of decades. There are also no moving parts or components that must be cleaned like a solar panel. The device does not lose its efficiency over time.

For centralized power generation, groups of these devices can be installed with larger and higher tower configurations resulting in higher voltage and current output per device. These “collector farms could be installed with a micro-grid configuration to power neighborhood, campuses and industrial parks.

Additionally, the technology could be used in space exploration to provide power on other planets. Planets with more charged atmospheres yield a possibility of manifesting a charge that is equal to or greater than that on earth.

It should be understood, of course, that the foregoing relates to exemplary embodiments of the invention and that modifications may be made without departing from the spirit and scope of the invention as set forth in the following claims.

What is claimed is:

1. A system for harvesting atmospheric ionic energy to generate useable electricity, comprising:
one or more collectors positioned in a preselected portion of the earth's electrostatic field, the one or more collectors configured to conduct a surface charge; and
a ground circuit electrically coupled to the one or more collectors, the ground circuit configured to distribute the surface charge so as to provide a potential difference between the one or more collectors and said preselected portion.

2. The system of claim 1, wherein the ground circuit her comprises an electrolytic circuit and a unidirectional circuit.

3. The system of claim 1, wherein the one or more collectors are conducting surfaces,

4. The system of claim 1, wherein the one or more collectors are positioned to optimize the collisions and/or attractions of naturally occurring ions.

5. The system of claim 3, wherein the conducting surfaces are connected to a single point of high ground potential for instilling the potential difference.

6. The system of claim 1, further comprising an elongated member for positioning one or more collectors.

7. The system of claim 1, further comprising an electrostatic conversion apparatus coupled to the ground circuit for converting the surface charge to an electrical charge.

8. The system of claim 1, wherein the electrostatic conversion apparatus is a electrostatic motor or spark gap.

9. A system for harvesting atmospheric ionic energy to generate useable electricity, comprising:
one or more collectors positioned in a preselected portion of the earth's electrostatic field, the one or more collectors provide a conducting surface configured to conduct a surface charge;
a ground circuit electrically coupled to the one or more collectors;
the ground circuit comprises an electrolytic circuit and a unidirectional circuit configured to distribute the surface charge so as to provide a potential difference between the one or more collectors and said preselected portion,
wherein the conducting surfaces are connected to a single point of high ground potential for instilling the potential difference; and
an electrostatic conversion apparatus coupled to the ground circuit for converting the surface charge to an electrical charge.

10. The system of claim 9, wherein the electrostatic conversion apparatus is an electrostatic motor or spark gap.
